(19) United States
(12) Patent Application Publication
(10) Pub. No.: US 2024/0323797 A1
(43) Pub. Date: Sep. 26, 2024

(54) CONDITIONAL HANDOVER

(71) Applicant: Nokia Technologies Oy, Espoo (FI)

(72) Inventors: Jedrzej STANCZAK, Wroclaw (PL); István Zsolt KOVÁCS, Aalborg (DK); Mads LAURIDSEN, Aalborg (DK); Ping YUAN, Beijing (CN)

(21) Appl. No.: 18/575,605

(22) PCT Filed: Jul. 17, 2021
(86) PCT No.: PCT/CN2021/106967

§ 371 Date: Dec. 29, 2023

(51) Int. Cl. H04W 36/36; H04W 36/00; H04W 36/08

(52) U.S. Cl. CPC H04W 36/362; H04W 36/0083; H04W 36/08

(57) ABSTRACT

Embodiments of the present disclosure relate to conditional handover. A method comprises: upon a successful handover to a first target cell in an ordered list of target cells configured for a terminal device to initiate handover in order, determining, at the terminal device, information for assessing a validity of the ordered list; and transmitting, to a first network device providing the first target cell, a first message comprising the information for assessing the validity of the ordered list. In this way, a chain of target cells is capable of preparing for the future handover from the suitable time, which avoids reserving resources too early or too late and improves the resource efficiency. Moreover, the current serving cell can detect the deviation of the terminal device from the chain in time, thus a configuration of the ordered list can be appropriately adjusted or updated.

### FIELD

Embodiments of the present disclosure generally relate to the field of telecommunication and in particular, to methods, devices, apparatuses and computer readable storage media for conditional handover.

### BACKGROUND

The New Radio (NR) non-terrestrial network (NTN) system aims to improve the network coverage on the ground and enhance the mobility robustness of mobile devices, such as terminal devices, user equipment (UE), relay network devices and so on. In typical application scenarios, low-earth orbit (LEO) satellites are deployed at altitudes of 600 km to 1200 km to support a transparent architecture that facilitates communication between UEs and a base station on the ground. The LEO satellites move at a speed of about 7.5 km/s relative to Earth, and the number of LEO satellites may depend on the targeted coverage and service. In some other scenarios, the base station may be deployed onboard the satellites.

Due to the movement of satellites, terminal devices in the NTN may have to frequently access to a target cell from the source cell through a handover procedure. A conditional handover (CHO) mechanism has been proposed to facilitate the handover procedure in the NTN. Specifically, a sequence of cells that a terminal device is likely to access through the HO procedure is predictable since the satellites move over orbits in a predefined way while the terminal device is relatively stationary compared to the movement of satellites. The sequence of cells may be indicated, for example, in an ordered list of cells, and the order of cells in the list corresponds to the order in which the terminal device accesses the cells. In this way, the sequence of cells is capable of preparing for the future access in advance.

### SUMMARY

In general, example embodiments of the present disclosure provide a solution for conditional handover.

In a first aspect, there is provided a terminal device. The terminal device comprises at least one processor; and at least one memory including computer program code; the at least one memory and the computer program code are configured to, with the at least one processor, cause the terminal device to upon a successful handover to a first target cell in an ordered list of target cells configured for the terminal device to initiate handover in order, determine information for assessing a validity of the ordered list; and transmit, to a first network device providing the first target cell, a first message comprising the information for assessing the validity of the ordered list.

In a second aspect, there is provided a first network device. The first network device comprises at least one processor; and at least one memory including computer program code, the at least one memory and the computer program code are configured to, with the at least one processor, cause the first network device to: upon a successful handover of a terminal device to a first target cell provided by the first network device, determine a stay time of the terminal device in the first target cell, the first target cell being one of an ordered list of target cells for the terminal device to initiate handover in order; and cause at least one further cell to prepare for at least one upcoming handover based on the stay time.

In a third aspect, there is provided a second network device. The second network device comprises at least one processor; and at least one memory including computer program code, the at least one memory and the computer program code are configured to, with the at least one processor, cause the second network device to: receive, from a first network device providing a first target cell, a fourth message indicating a stay time of the terminal device in the first target cell, the first target cell being one of an ordered list of target cells for the terminal device to initiate handover in order; and reserve, based on the stay time, resources from at least one further cell for at least one upcoming handover of the terminal device, the at least one further cell provided by the second network device.

In a fourth aspect, there is provided a method. The method comprises: upon a successful handover to a first target cell in an ordered list of target cells configured for a terminal device to initiate handover in order, determining, at the terminal device, information for assessing a validity of the ordered list; and transmitting, to a first network device providing the first target cell, a first message comprising the information for assessing the validity of the ordered list.

In a fifth aspect, there is provided a method. The method comprises: upon a successful handover of a terminal device to a first target cell provided by a first network device, determining, at the first network device, a stay time of the terminal device in the first target cell, the first target cell being one of an ordered list of target cells for the terminal device to initiate handover in order; and causing at least one further cell to prepare for at least one upcoming handover based on the stay time.

In a sixth aspect, there is provided a method. The method comprises: receiving, at a second network device and from a first network device providing a first target cell, a fourth message indicating a stay time of the terminal device in the first target cell, the first target cell being one of an ordered list of target cells for the terminal device to initiate handover in order; and reserving, based on the stay time, resources from at least one further cell for at least one upcoming handover of the terminal device, the at least one further cell provided by the second network device.

In a seventh aspect, there is provided a first apparatus. The first apparatus comprises: means for upon a successful handover to a first target cell in an ordered list of target cells configured for the first apparatus to initiate handover in order, determining information for assessing a validity of the ordered list; and means for transmitting, to a first network device providing the first target cell, a first message comprising the information for assessing the validity of the ordered list.

In an eighth aspect, there is provided a second apparatus. The second apparatus comprises: means for upon a successful handover of a terminal device to a first target cell provided by the second apparatus, determining a stay time of the terminal device in the first target cell, the first target cell being one of an ordered list of target cells for the terminal device to initiate handover in order; and means for causing at least one further cell to prepare for at least one upcoming handover based on the stay time.

In a ninth aspect, there is provided a third apparatus. The third apparatus comprises: means for receiving, from a first network device providing a first target cell, a fourth message indicating a stay time of the terminal device in the first target cell, the first target cell being one of an ordered list of target cells for the terminal device to initiate handover in order; and means for reserving, based on the stay time, resources from at least one further cell for at least one upcoming handover of the terminal device, the at least one further cell provided by the second network device.

In a tenth aspect, there is provided a non-transitory computer readable medium comprising program instructions for causing an apparatus to perform at least the method according to the above fourth aspect.

In an eleventh aspect, there is provided a non-transitory computer readable medium comprising program instructions for causing an apparatus to perform at least the method according to the above fifth aspect.

In a twelfth aspect, there is provided a non-transitory computer readable medium comprising program instructions for causing an apparatus to perform at least the method according to the above sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which embodiments of the present disclosure may be implemented;

FIG. 2 illustrates a signaling flow for conditional handover in accordance with some example embodiments of the present disclosure;

FIG. 3 illustrates a flowchart of a method implemented at a first device in accordance with some example embodiments of the present disclosure;

FIG. 4 illustrates a flowchart of a method implemented at a second device in accordance with some example embodiments of the present disclosure;

FIG. 5 illustrates a flowchart of a method implemented at a third device in accordance with some example embodiments of the present disclosure;

FIG. 6 illustrates a simplified block diagram of an apparatus that is suitable for implementing embodiments of the present disclosure; and

FIG. 7 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems, including but not limited to a terrestrial communication system, a non-terrestrial communication system or a combination thereof. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

In NTN, the satellites move over respective orbits in a predefined way and provide a plurality of cells or footprints on the ground. Compared to the satellites' motion, the UE can be regarded as stationary. For a cell size of 50 to 100 km, the movement of the satellites may result in handover performed between different cells at every 6.5 to 13 seconds, even for stationary UEs. The CHO mechanism can increase the handover robustness by decoupling the HO preparation and execution phrases. In particular, future handover in next few hops is predictable based on, for example, the movement of the satellites and the initial geo-location of the UE. A sequence of cells that is likely to be accessed by the UE may be indicated in an ordered list of target cells. These target cells associated with CHO may then reserve resources in advance for the future handover.

However, from the perspective of the target cells, reserving resources too early or too late is undesirable. For example, this may result in lack of resources for random access preambles, especially for contention-free random access (CFRA). Moreover, it may be problematic of reservation for supporting specific radio bearers the UE may have at the time it is prepared with the chain of CHO commands.

Moreover, the current serving cell may only know a part of the sequence of CHO, for example, the direct predecessor and the successor cell. In this case, the current serving cell is unaware of all the details and configurations about future preparations, e.g., for how many cells the UE has a CHO configuration, etc. The configuration for the entire chain of CHO may not be propagated across multiples nodes over the network. Further, the nodes associated with the target cells may not know UE's identity, and perhaps only know a rough resource reservation estimation without individual distribution per UE and the future cells. In another implementation, the UE identity can be known, e.g., AMF-level identifier, such as 5G Globally Unique Temporary UE Identity (GUTI). Thus, it is difficult for each cell in the list to reserve resources accurately.

In order to solve the above and other potential problems, embodiments of the present disclosure provide an enhanced CHO mechanism. In general, after successfully handing over to a cell, the terminal device reports information for assessing a validity of the chain of CHO. The current serving cell can determine whether the terminal device is deviated from the chain of CHO, or whether the chain of CHO is still valid based on such information. Additionally, the information may help estimate a stay time of the terminal device in current serving cell. By providing the stay time to one or more next nodes in the list, the next few cells can prepare for the upcoming handover with resources at the appropriate time.

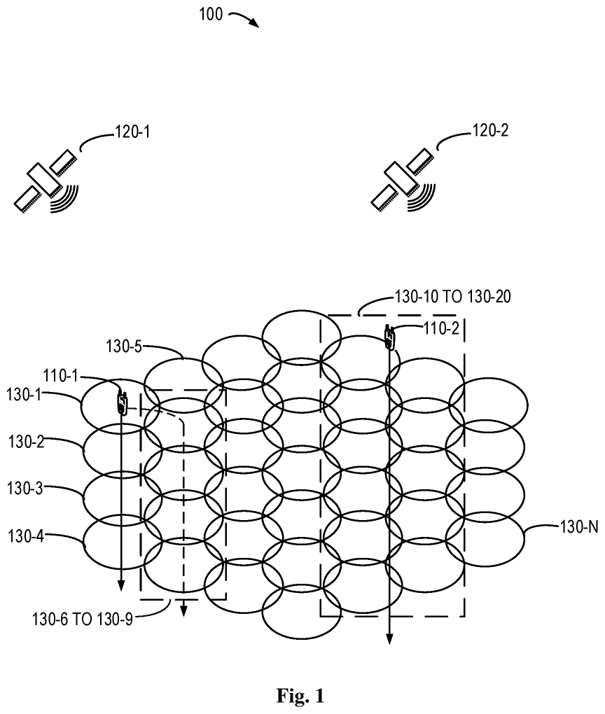

FIG. 1 illustrates an example communication environment 100 in which embodiments of the present disclosure may be implemented. The example communication environment 100 may comprise terminal devices 110-1 and 110-2 (which may be collectively referred to as the terminal device 110), a first network device 120-1 and a second network device 120-2 (which may be collectively referred to as the network device 120).

The first network device 120-1 and the second network device 120-2 may comprise base stations, such as, gNBs. As shown in FIG. 1, the first network device 120-1 and the second network device 120-2 are deployed at non-terrestrial (NT) network devices, such as, satellites or an unmanned aerospace surveillance (UAS) platform that is able to generate beams (e.g., satellite beams) for providing network coverage. In a case where the first network device 120-1 and the second network device 120-2 are deployed at LEO or Medium Earth Orbit (e.g., MEO) satellites, the radio coverage footprint, i.e., the footprint of satellite beams moves together with the satellites and provides the Earth Moving cells (EMC), i.e., cells 130-1 to 130-N (which may be collectively referred to as cells 130). The cells 130-1 to 130-N may be provided by at least one of the first network device 120-1 and the second network device 120-2

In some embodiments where the network device 120 is onboard the NT network device, it has a regenerative payload. In some other embodiments, the NT devices may have a transparent payload, because it acts as a relay for signals transmitted from the first network device 120-1 and the second network device 120-2 to the terminal device 110 on the Earth.

The terminal devices 110-1 and 110-2 are located within the network coverage and can communication with each other or with the network device 120. Since the NT devices move with a high speed (e.g., 7.5 km/s) along their orbit, the cells 130-1 to 130-N move with almost the same speed. As compared with the moving satellites, the terminal device 110 may be regarded as stationary. As a result, a frequent handover may occur among different cells at a few seconds to a few 10s of seconds depending on the exact orbit of the NT network device, beam footprint size, etc.

In some example embodiments, a sequence of cells 130 that the terminal device 110 is likely to access through the HO procedure is predictable based on the movement of satellites and the terminal device's geo-location in the network coverage. For example, for the terminal device 110-1 located in the center of an initial cell (i.e., cell 130-1) and the first network device 120-1 that provides cells 130-1 to 130-4 and moves from north to south, a trajectory of the terminal device 110-1 within the network coverage is estimated to be cell 130-1→cell 130-2→cell 130-3→cell 130-4, and thus a sequence of future HOs is very likely to be performed in these cells in turn. For the terminal device 110-2 located at edge of cell 130-8, it may be estimated to perform a sequence of HOs between several neighboring cells 130-10 to 130-20, and the number of HOs may be larger than the number of HOs for the terminal device 110-1.

The terminal device 110 may be configured with an ordered list of target cells via RRC reconfiguration message, which indicates a chain of handover to be performed in next few hops. In other words, the ordered list describes an estimated cell-trajectory of the terminal device 110 associated with future handover. Once a predetermined handover condition is met, the terminal device 110 may select one of the target cells and perform a handover procedure from the current serving cell to the selected target cell. For each hop, there may be more than one target cell prepared by, for example, reserving resources for CHO. Since only one CHO will eventually be executed, the rest of the target cells that are not selected will be deconfigured and the reserved resources will be released.

To facilitate the future handover for the next few hops, the network device 120 providing the current serving cell may determine a stay time of the terminal device 110 in the current serving cell. The stay time may be used by the target cells for future handover to prepare for the upcoming handover.

In some cases, the terminal device 110 may deviate from the estimated cell-trajectory, for example, deviation to a sequence of cells 130-6 to 130-9. To facilitate the CHO, the current serving cell may determine whether the configured ordered list is valid, that is, whether the future handover of the terminal device 110 will deviate from the ordered list. Upon successfully handover to one of the target cells, for example, the first target cell 130-1 in the ordered list of target cells 130-1 to 130-4, the terminal device 110-1 may determine information for assessing a validity of the ordered list, and transmit the information to the first target cell 130-1. Once the first target cell 130-1 determines that the ordered list is invalid, the first target cell 130-1 may determine a new ordered list that is at least partially different from the order list, or alternatively, a configuration for handover in the next hop.

In the examples shown in FIG. 1, the NT network devices are illustrated as satellites in the non-terrestrial network scenario, and the first network device 120-1 and the second network device 120-2 are illustrated as base stations on-board the satellites. However, it would be appreciated that the NT network devices, the first network device 120-1 and the second network device 120-2 may comprise any other types of network device. It should be understood that, in other implementations, the first network device 120-1 and the second network device 120-2 may be deployed on the ground.

It is to be understood that the number of network devices, terminal devices and/or cells is given for the purpose of illustration without suggesting any limitations to the present disclosure. The communication network 100 may include any suitable number of network devices, terminal devices and/or cells adapted for implementing implementations of the present disclosure. Although not shown, it would be appreciated that one or more additional devices may be located in the cells 130-1 to 130-N, and one or more additional cells may be deployed in the communication network 100.

In the communication network 100 as shown in FIG. 1, the network device 120 can communicate data and control information to the terminal device 110 and the terminal device 110 can also communication data and control information to the corresponding network device 120. A link from the network device 120 to the terminal device 110 is referred to as a downlink (DL), while a link from the terminal device 110 to the network device 120 is referred to as an uplink (UL). In DL, the network device 120 is a transmitting (TX) device (or a transmitter) and the terminal device 110 is a receiving (RX) device (or a receiver). In UL, the terminal device 110 is a TX device (or a transmitter) and the network device 120 is a RX device (or a receiver).

Communications in the communication network 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

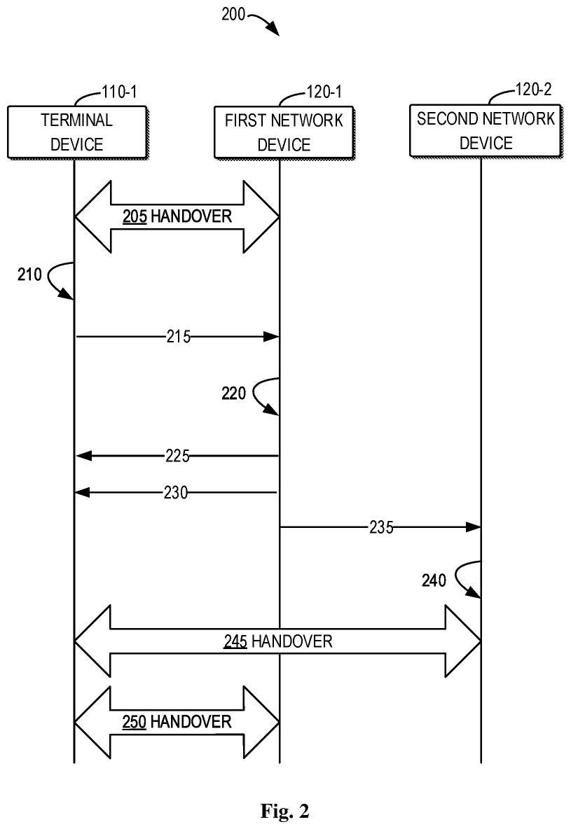

To better understand the conditional handover procedure proposed in the disclosure, reference is now made to FIG. 2, which illustrates a signaling flow 200 for conditional handover in accordance with some example embodiments of the present disclosure. For the purpose of discussion, the signaling flow 200 will be described with reference to FIG. 1. The signaling flow 200 may involve the terminal device 110-1, the first network device 120-1 and the second network device 120-2 as illustrated in FIG. 1. It is to be understood that the process 200 is also applicable to the communication network 100 as shown in FIG. 1 and other suitable communication networks whether currently existing or later developed.

In the process 200, the terminal device is 110-1 is configured with an ordered list of target cells 130-1 to 130-4 for CHO. The configuration of the ordered list may be provided from an initial serving cell, which includes but not limited to radio resources (e.g., random access channel (RACH), data radio bear (DRB), signaling radio bear (SRB) and so on) for accessing each of the target cells 130-1 to 130-4 in the list. The target cells 130-1 to 130-4 in the list may be provided from the same network device, e.g., either one of the first network device 120-1 or the second network device 120-2, or different network devices.

In a case where a preconfigured handover condition is met, the terminal device 110-1 performs 205 handover to the first target cell 130-1 provided by the first network device 120-1. Upon the successful handover to the first target cell 130-1, the terminal device 110-1 determines 210 information for assessing a validity of the ordered list. Such information may indicate a relevance of the trajectory of the terminal device 110-1 to the ordered list of target cells 130-1 to 130-4.

In some example embodiments, the information may include but not limited to an index of the first target cell 130-1 in the ordered list (e.g., index “1”), information indicating at least one target cell remaining in the ordered list to which the terminal device 110-1 is to handover to (e.g., indices of at least part of target cells remaining in the ordered list, e.g., indices “2”, “3” and “4”), and a number of target cells remaining in the ordered list to which the terminal device 110-1 is to handover (e.g., 3). In these embodiments, the terminal device 110-1 may generate a first message comprising the information for assessing a validity of the ordered list.

In some example embodiments, the information for assessing a validity of the ordered list may be determined based on channel measurement. In these embodiments, the first network device 120-1 may configure the terminal device 110-1 with measurement configuration. The terminal device 110-1 may measure, based on the measurement configuration configured by the first network device 120-1, at least one signal from at least one candidate cell 130-1 to 130-N to handover to. The terminal device 110-1 may then generate a first message comprising a result for measuring the at least one signal. The result for measuring may include, for example, RSRP, RSRQ and so on.

In some example embodiments, the information for assessing a validity of the ordered list may indicate whether a handover is initiated toward one of the target cells 130-1 to 130-4 in the order list before expiration of a validity timer associated with the ordered list. The validity timer may be used for controlling how long the terminal device 110-1 may act based on the configured chain. The validity timer may be configured by the network based on the moving speed of the NT devices and a relative movement of the terminal device 110-1. For example, the value t of the validity timer may correspond to the expected time the current serving cell will serve the terminal device 110-1.

If no handover is initiated toward the target cells 130-1 to 130-4 until expiration of the timer, the terminal device 110-1 may report it to the first network device 120-1, for example, by generating the first message comprising a first indication indicating no handover toward the order listed of target cells 130-1 to 130-4 is performed. For example, the first indication may be transmitted as a part of a measurement report (MR).

The terminal device 110-1 transmits 215 the first message comprising the information for assessing the validity of the ordered list to the first network device 120-1. In some example embodiments, the first message may be a RRC message, for example, the RRC reconfiguration complete message.

After the terminal device 110-1 has handed over to the first target cell 130-1, the first network device 120-1 determines 220 an averaged stay time of the terminal device in the first target cell 130-1. In some example embodiments, the first network device 120-1 may estimate the stay time of the terminal device 110-1 based on the information for assessing the validity of the ordered list received from the terminal device 110-1.

The first target cell 130-1 may determine whether the ordered list of target cells 130-1 to 130-4 is valid based on the information. If the ordered list of target cells 130-1 to 130-4 is valid, which indicates that the trajectory of the terminal device 110-1 is not deviated from the configured chain of CHO, the first network device 120-1 transmits 225, to the terminal device 110-1, a second message that includes a second indication indicating the ordered list of target cells 130-1 to 130-4 being valid.

In the above case, once a handover condition is met, the terminal device 110-1 may perform handover to the second target cell 130-2 configured with a second index listed next to a first index of the first target cell in the ordered list based on a configuration of the ordered list. Since there may be more than one target cell configured for each hop of CHO, that is, more than one target cell may be configured with the same index in the ordered list, the second target cell 130-2 may be selected from at least one target cell configured with the second index.

Otherwise, if the ordered list of target cells 130-1 to 130-4 is invalid, the first network device 120-1 may determine that the terminal device 110-1 deviates from the configured chain of CHO. In some example embodiments, the first network device 120-1 may then determine a new target cell for the next hop, for example, the third target cell 130-5 that is different from at least one target cell configured with a second index (e.g., the second target cell 130-2) listed next to a first index of the first target cell 130-1 in the ordered list.

The first network device 120-1 then transmits 230, to the terminal device 110-1, a third message that includes a configuration for handover to the third target cell 130-5. In some example embodiments, the third message may further comprise a configuration of a further ordered list of target cells 130-5 to 130-9 comprising the third target cell 130-5. For example, the configuration of the further ordered list of target cells 130-5 to 130-9 may indicate a new chain of CHO. The third target cell may be one of at least one target cell configured with a specific index in the further ordered list.

Alternatively, in a case where the terminal device 110-1 has been configured with multiple chains of CHO, the first network device 120-1 may indicate which of the multiple configurations of chains is to be used for future CHO.

The first network device 120-1 may cause at least one further cell to prepare for at least one upcoming handover based on the stay time. From the stay time, the at least one further cell is aware when the terminal device 110-1 is expected to access, and thus resources in these cells may be reserved for the upcoming handover.

In some example embodiments where the at least one further cell is provided by the second network device 120-2, the first network device 120-1 transmits 235 a fourth message indicating the stay time to the second network device 120-2. In these embodiments, the second network device 120-2 reserves 240 resources from the at least one further cell for the at least one upcoming handover. The terminal device 110-1 may evaluate the preconfigured handover condition (e.g., the CHO execution condition). Once the handover condition is met, the terminal device 110-1 may perform 245 handover to the at least one further cell with the second network device 120-2.

In some example embodiments where the at least one further cell is also provided by the first network device 120-1, the first network device 120-1 may reserve, based on the stay time, resources from the at least one further cell for the at least one upcoming handover. The terminal device 110-1 may evaluate the preconfigured handover condition (e.g., the CHO execution condition). Once the handover condition is met, the terminal device 110-1 may perform 250 handover to the at least one further cells with the first network device 120-1.

According to the example embodiments of the present disclosure, an enhanced CHO mechanism is provided. In the enhanced mechanism, after each CHO, the terminal device reports information for assessing a validity of CHO chain to the current serving cell. With such information, the current serving cell can detect the deviation of the terminal device from the chain in time, thus a configuration of the ordered list can be appropriately adjusted or updated. Further, the network node managing the current serving cell determines a stay time of the terminal device in the current serving cell and provides the stay time to the target cells in the next hops. In this way, the target cells can avoid reserving resources too early or too late and thus the resource efficiency is improved.

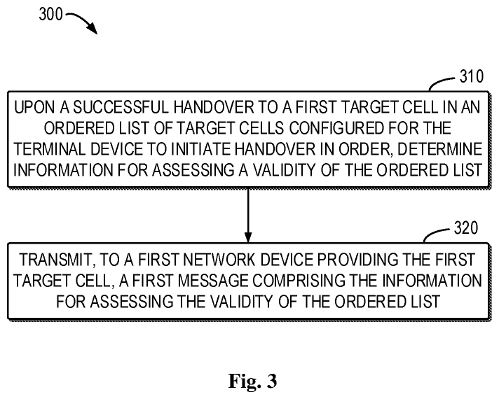

FIG. 3 shows a flowchart of an example method 300 according to some example embodiments of the present disclosure. The method 300 can be implemented at a device e.g. at the terminal device 110-1 as shown in FIG. 1. For the purpose of discussion, the method 300 will be described with reference to FIG. 1. It is to be understood that the method 300 is also applicable to other suitable communication networks whether currently existing or later developed.

At block 310, upon a successful handover to the first target cell 130-1 in an ordered list of target cells 130-1 to 130-4 configured for the terminal device 110-1 to initiate handover in order, the terminal device 110-1 determines information for assessing a validity of the ordered list. In some example embodiments, the information for assessing the validity of the ordered list may indicate a position of the terminal device 110-1 in the ordered list of target cells 130-1 to 130-N.

In some example embodiments, the information for assessing the validity of the ordered list indicates may include but not limited to an index of the first target cell 130-1 in the ordered list (e.g., index “1”), information indicating at least one target cell remaining in the ordered list to which the terminal device 110-1 is to handover to (e.g., indices for at least part of target cells remaining in the ordered list, such as, “2”, “3”, “4”), or a number of target cells remaining in the ordered list to which the terminal device 110-1 is to handover (e.g., 3).

In some example embodiments, to determine the information for assessing a validity of the ordered list, the terminal device 110-1 may measure, based on a measurement configuration configured by the first network device 120-1, at least one signal from at least one candidate cell to handover to. The terminal device 110-1 may then generate the first message comprising a result for measuring the at least one signal.

In some example embodiments, to determine the information for assessing a validity of the ordered list, the terminal device 110-1 may determine whether a handover is initiated toward one of the target cells 130-1 to 130-4 in the order listed before expiration of a validity timer associated with the ordered list. The validity timer may be used for controlling how long the terminal device 110-1 may act based on the configured chain. The validity timer may be configured by the network based on the moving speed of the NT devices and a relative movement of the terminal device 110-1. For example, the value t of the validity timer may correspond to the expected time the current serving cell will serve the terminal device 110-1.

If no no handover is initiated toward one of the target cells 130-1 to 130-4 in the order listed until expiration of a validity timer associated with the ordered list, the terminal device 110-1 may generate the first message comprising a first indication indicating no handover toward the order listed of target cells 130-1 to 130-4 is performed.

At block 320, the terminal device 110-1 transmits, to the first network device 120-1 providing the first target cell 130-1, a first message comprising the information for assessing the validity of the ordered list. In some example embodiments, the first message may be a RRC message, for example, the RRC reconfiguration complete message.

After transmitting the first message, the terminal device 110-1 may then receive at least one message from the first network device 120-1. In some example embodiments, the terminal device 110-1 may receive, from the first network device 120-1, a second message comprising a second indication indicating the ordered list of target cells 130-1 to 130-4 being valid. If a handover condition is met, the terminal device 110-1 may then initiate handover from the first target cell 130-1 to the second target cell 130-2 based on a configuration of the ordered list. The second target cell 130-2 may be configured with a second index listed next to a first index of the first target cell 130-1 in the ordered list. In some example embodiments, the terminal device 110-1 may select the second target cell 130-2 from at least one target cell configured with the second index based on evaluation of the at least one target cell.

In some example embodiments, the terminal device 110-1 may receive, from the first network device 120-1, a third message comprising a configuration for handover to the third target cell 130-5 determined based on the information for assessing a validity of the ordered list. The third target cell 130-5 is different from at least one target cell configured with a second index (e.g., the second target cell 130-2) listed next to a first index of the first target cell 130-1 in the ordered list. If a handover condition is met, the terminal device 110-1 may then initiate handover from the first target cell 130-1 to the third target cell 130-5 based on the configuration for handover to the third target cell 130-5. In some example embodiments, the terminal device 110-1 may select the third target cell 130-5 from at least one target cell configured with a specific index in the further ordered list based on evaluation of the at least one target cell.

In some example embodiments, the third message may further include a configuration of a further ordered list of target cells 130-5 to 130-9 comprising the third target cell 130-5, and the further ordered list is at least partially different from the ordered list. For example, the further ordered list may indicate an updated CHO of cell 130-5→cell 130-6→cell 130-7→cell 130-8→cell 130-9. In some example embodiments, the third message may further comprise a configuration of a further ordered list of target cells 130-5 to 130-9 comprising the third target cell 130-5. For example, the configuration of the further ordered list of target cells 130-5 to 130-9 may indicate a new chain of CHO. Alternatively, in a case where the terminal device 110-1 has been configured with multiple chains of CHO, the first network device 120-1 may indicate which of the multiple configurations of chains is to be used for future CHO.

According to the example embodiments of the present disclosure, an enhanced CHO mechanism is provided. In the enhanced mechanism, after each successful CHO, the UE reports information used for assessing a validity of CHO chain to the current serving cell. The current serving cell can determine whether the UE deviates from a configured chain of target cells in time based on the information. As such, the network node managing the current serving cell is capable of adjusting or updating the configuration of the ordered list appropriately. Further, the network node managing the current serving cell can estimate a stay time of the terminal device in the current serving cell from such information and provides the stay time to the target cells in the next hops. In this way, the target cells can avoid reserving resources too early or too late and thus the resource efficiency is improved.

FIG. 4 shows a flowchart of an example method 400 according to some example embodiments of the present disclosure. The method 400 can be implemented at a device e.g., at the first network device 120-1 as shown in FIG. 1. For the purpose of discussion, the method 400 will be described with reference to FIG. 1. It is to be understood that the method 400 is also applicable to other suitable communication networks whether currently existing or later developed.

At block 410, upon a successful handover of the terminal device 110-1 to the first target cell 130-1 provided by the first network device 120-1, the first network device 120-1 determines a stay time of the terminal device 110-1 in the first target cell 130-1. The first target cell 130-1 may be one of an ordered list of target cells 130-1 to 130-4 for the terminal device 110-1 to initiate handover in order.

In some example embodiments, the stay time may be determined based on at least one of the following: a cell identity of the first target cell 130-1, geo-location data of the terminal device 110-1, a movement of the terminal device 110-1 (e.g., a moving speed or a moving direction of the terminal device 110-1), a moving speed of the first network device 120-1, an estimated trajectory of the first network device 120-1, and an estimated swap of coverage of the first network device 120-1.

In some example embodiments, to determine the stay time, the first network device 120-1 may receive, from the terminal device 110-1, a first message comprising information for assessing a validity of the ordered list. In some example embodiments, the first message may be a RRC message, for example, the RRC reconfiguration complete message. The first network device 120-1 may then determine the stay time based on the information.

In some example embodiments, the information for assessing the validity of the ordered list indicates may include but not limited to an index of the first target cell 130-1 in the ordered list (e.g., index “1”), information indicating at least one target cell remaining in the ordered list to which the terminal device 110-1 is to handover to (e.g., indices for at least part of target cells remaining in the ordered list, such as, “2”, “3”, “4”), or a number of target cells remaining in the ordered list to which the terminal device 110-1 is to handover (e.g., 3).

In some example embodiments, the information for assessing a validity of the ordered list may include a result for measuring at least one signal from at least one candidate cell 130-1 to 130-N to handover to. In these embodiments, the first network device 120-1 may transmit, to the terminal device 110-1, a measurement configuration for measuring the at least one signal from the at least one candidate cell 130-1 to 130-N.

In some example embodiments, the information for assessing a validity of the ordered list may include a first indication indicating no handover toward the order listed of target cells 130-1 to 130-4 is performed until expiration of a validity timer associated with the ordered list. The validity timer may be used for controlling how long the terminal device 110-1 may act based on the configured chain. The validity timer may be configured by the network based on the moving speed of the NT devices and a relative movement of the terminal device 110-1. For example, the value t of the validity timer may correspond to the expected time the current serving cell will serve the terminal device 110-1.

In absence of the information, the first network device 120-1 may determine that a handover toward the target cells 130-1 to 130-4 in the ordered list is performed before the expiration of the timer.

In some example embodiments, the first network device 120-1 may determine whether the ordered list of target cells 130-1 to 130-4 is valid based on the information. If the ordered list of target cells 130-1 to 130-4 is valid, the first network device 120-1 may transmit, to the terminal device 110-1, a second message comprising a second indication indicating the ordered list of target cells 130-1 to 130-4 being valid. In this case, the terminal device 110-1 may initiate CHO based on the configuration of the ordered list once a handover condition is met.

If the ordered list of target cells 130-1 to 130-4 is invalid, the first network device 120-1 may determine the third target cell 130-5 for the terminal device 110-1 to handover to. In some example embodiments, the third target cell 130-5 may be different from at least one target cell configured with a second index (e.g., the second target cell 130-2) listed next to a first index of the first target cell 130-1 in the ordered list. The first network device 120-1 may then transmit, to the terminal device 110-1, a third message comprising a configuration for handover to the third target cell 130-5.

In some example embodiments, the third message may further include a configuration of a further ordered list of target cells 130-5 to 130-9 comprising the third target cell 130-5, and at least one target cell may be configured for each of indices in the ordered list. The further ordered list is at least partially different from the ordered list. For example, the further ordered list may indicate an updated CHO of cell 130-5→cell 130-6→cell 130-7→cell 130-8→cell 130-9. In some example embodiments, the third message may further comprise a configuration of a further ordered list of target cells 130-5 to 130-9 comprising the third target cell 130-5. For example, the configuration of the further ordered list of target cells 130-5 to 130-9 may indicate a new chain of CHO. Alternatively, in a case where the terminal device 110-1 has been configured with multiple chains of CHO, the first network device 120-1 may indicate which of the multiple configurations of chains is to be used for future CHO.

At 420, the first network device 120-1 causes at least one further cell to prepare for at least one upcoming handover based on the stay time. In the case where the at least one further cell is provided by a different network device (e.g., the second network device 120-2), the first network device 120-1 may transmit a fourth message indicating the stay time to the second network device 120-2.

In the case where the at least one further cell is provided by the first network device 120-1, the first network device 120-1 may reserve, based on the stay time, resources from the at least one further cell for the at least one upcoming handover.

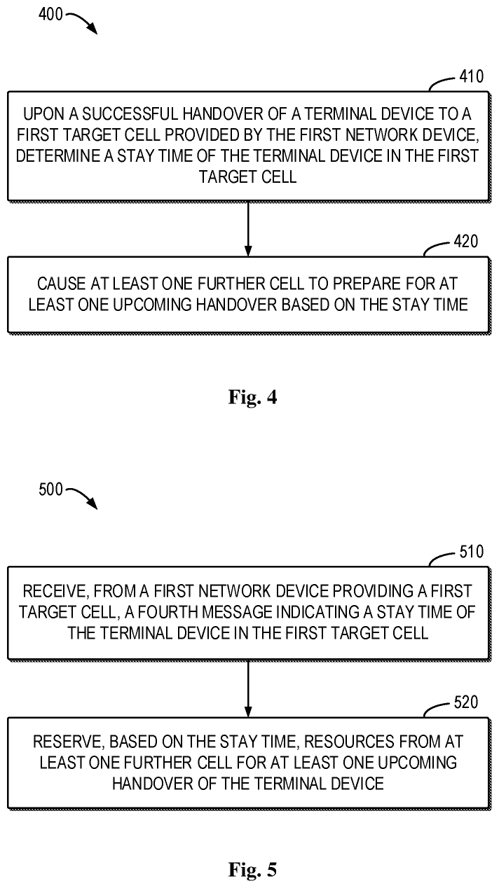

FIG. 5 shows a flowchart of an example method 500 according to some example embodiments of the present disclosure. The method 500 can be implemented at a device e.g., at the second network device 120-2 as shown in FIG. 1. For the purpose of discussion, the method 500 will be described with reference to FIG. 1. It is to be understood that the method 500 is also applicable to other suitable communication networks whether currently existing or later developed.

At block 510, the second network device 120-2 receives, from the first network device 120-1 providing the first target cell 130-1, a fourth message indicating a stay time of the terminal device 110-1 in the first target cell 130-1. The first target cell 130-1 is one of an ordered list of target cells 130-1 to 130-4 for the terminal device 110-1 to initiate handover in order.

In some example embodiments, the at least cell may include the second target cell 130-2 configured with a second index listed next to a first index of the first target cell 130-1 in the ordered list. In this case, the trajectory of the terminal device 110-1 is not deviated from the configured chain of CHO.

In some example embodiments, the at least cell may include the third target cell 130-5 different from at least one target cell configured with the second index (e.g., the second target cell 130-2) listed next to the first index of the first target cell 130-1 in the ordered list. In this case, the trajectory of the terminal device 110-1 is deviated from the configured chain of CHO.

In some example embodiments, the stay time may be determined based on at least one of the following: a cell identity of the first target cell 130-1, geo-location data of the terminal device 110-1, a movement of the terminal device 110-1 (e.g., a moving speed or a moving direction of the terminal device 110-1), a moving speed of the first network device 120-1, an estimated trajectory of the first network device 120-1, and an estimated swap of coverage of the first network device 120-1.

At block 520, the second network device 120-2 reserves, based on the stay time, resources from at least one further cell for at least one upcoming handover of the terminal device 110-1. In this case, the at least one further cell is provided by the second network device 120-2.

In this way, candidate cells in the footprints of satellites are aware of the current position of the UE in a configured chain of CHO based on the stay time, and resources can be reserved for the upcoming handover from an appropriate time. As such, the resource efficiency in the communication system can be improved.

In some example embodiments, a first apparatus capable of performing the method 300 may comprise means for performing the respective steps of the method 300. The means may be implemented in any suitable form. For example, the means may be implemented in a circuitry or software module.

In some example embodiments, the first apparatus comprises: means for upon a successful handover to a first target cell in an ordered list of target cells configured for the first apparatus to initiate handover in order, determining information for assessing a validity of the ordered list; and means for transmitting, to a first network device providing the first target cell, a first message comprising the information for assessing the validity of the ordered list.

In some example embodiments, the information for assessing the validity of the ordered list comprises one of the following: an identifier of the first target cell, an index of the first target cell in the ordered list, or information indicating at least one target cell remaining in the ordered list to which the terminal device is to handover to.

In some example embodiments, the means for determining the information for assessing a validity of the ordered list comprises: means for measuring, based on a measurement configuration configured by the first network device, at least one signal from at least one candidate cell to handover to; and means for generating the first message comprising a result for measuring the at least one signal.

In some example embodiments, the means for determining the information for assessing a validity of the ordered list comprises: means for in accordance with a determination that no handover is initiated toward one of the target cells in the order listed until expiration of a validity timer associated with the ordered list, generating the first message comprising a first indication indicating no handover toward the order listed of target cells is performed.

In some example embodiments, the first apparatus further comprises: means for receiving, from the first network device, a second message comprising a second indication indicating the ordered list of target cells being valid; and means for in accordance with a determination that a handover condition is met, initiating handover from the first target cell to a second target cell based on a configuration of the ordered list, the second target cell is configured with a second index listed next to a first index of the first target cell in the ordered list, and the second target cell is selected from at least one target cell configured with the second index.

In some example embodiments, the first apparatus further comprises: means for receiving, from the first network device, a third message comprising a configuration for handover to a third target cell determined based on the information for assessing a validity of the ordered list, the third target cell being different from at least one target cell configured with a second index listed next to a first index of the first target cell in the ordered list; and means for in accordance with a determination that a handover condition is met, initiating handover from the first target cell to the third target cell based on the configuration for handover to the third target cell.

In some example embodiments, the third message further comprises a configuration of a further ordered list of target cells comprising the third target cell, the third target cell is selected from at least one target cell configured with a specific index in the further ordered list, and the further ordered list is different from the ordered list.

In some example embodiments, a second apparatus capable of performing the method 400 may comprise means for performing the respective steps of the method 400. The means may be implemented in any suitable form. For example, the means may be implemented in a circuitry or software module.

In some example embodiments, the second apparatus comprises: means for upon a successful handover of a terminal device to a first target cell provided by the second apparatus, determining a stay time of the terminal device in the first target cell, the first target cell being one of an ordered list of target cells for the terminal device to initiate handover in order; and means for causing at least one further cell to prepare for at least one upcoming handover based on the stay time.

In some example embodiments, the stay time is determined based on at least one of the following: a cell identity of the first target cell, a cell identity of the first target cell, a movement of the terminal device comprising at least one of a moving speed or a moving direction of the terminal device, a moving speed of the first network device, an estimated trajectory of the first network device, and an estimated swap of coverage of the first network device.

In some example embodiments, the means for determining the stay time comprises: means for receiving, from the terminal device, a first message comprising information for assessing a validity of the ordered list; and means for determining the stay time based on the information.

In some example embodiments, the information for assessing the validity of the ordered list comprises one of the following: an identifier of the first target cell, an index of the first target cell in the ordered list, or information indicating at least one target cell remaining in the ordered list to which the terminal device is to handover to.

In some example embodiments, the information for assessing a validity of the ordered list comprises a result for measuring at least one signal from at least one candidate cell to handover to, and the second apparatus further comprises: means for transmitting, to the terminal device, a measurement configuration for measuring the at least one signal from the at least one candidate cell.

In some example embodiments, the information for assessing a validity of the ordered list comprises a first indication indicating no handover toward the order listed of target cells is performed until expiration of a validity timer associated with the ordered list.

In some example embodiments, the second apparatus further comprises: means for determining whether the ordered list of target cells is valid based on the information; and means for in accordance with a determination that the ordered list of target cells is valid, transmitting, to the terminal device, a second message comprising a second indication indicating the ordered list of target cells being valid.

In some example embodiments, the second apparatus further comprises: means for determining whether the ordered list of target cells is valid based on the information; means for in accordance with a determination that the ordered list of target cells is invalid, determining a third target cell for the terminal device to handover to, the third target cell being different from at least one target cell configured with a second index listed next to a first index of the first target cell in the ordered list; and means for transmitting, to the terminal device, a third message comprising a configuration for handover to a third target cell.

In some example embodiments, the third message further comprises a configuration of a further ordered list of target cells comprising the third target cell, and at least one target cell is configured for each of indices in the ordered list.

In some example embodiments, the means for causing at least one further cell to prepare for the at least one upcoming handover: means for transmitting, to a second network device providing the at least one further cell, a fourth message indicating the stay time.

In some example embodiments, the at least one further cell is provided by the first network device, and the means for causing at least one further cell to prepare for the at least one upcoming handover: means for reserving, based on the stay time, resources from the at least one further cell for the at least one upcoming handover.

In some example embodiments, a third apparatus capable of performing the method 500 may comprise means for performing the respective steps of the method 500.

The means may be implemented in any suitable form. For example, the means may be implemented in a circuitry or software module.

In some example embodiments, a third apparatus comprises: means for receiving, from a first network device providing a first target cell, a fourth message indicating a stay time of the terminal device in the first target cell, the first target cell being one of an ordered list of target cells for the terminal device to initiate handover in order; and means for receiving, from a first network device providing a first target cell, a fourth message indicating a stay time of the terminal device in the first target cell, the first target cell being one of an ordered list of target cells for the terminal device to initiate handover in order.

In some example embodiments, the at least cell comprises a second target cell configured with a second index listed next to a first index of the first target cell in the ordered list.

In some example embodiments, the at least cell comprises a third target cell different from at least one target cell configured with a second index listed next to a first index of the first target cell in the ordered list.

In some example embodiments, the stay time is determined based on at least one of the following: a cell identity of the first target cell, geo-location data of the terminal device, a movement of the terminal device comprising at least one of a moving speed or a moving direction of the terminal device, a moving speed of the first network device, an estimated trajectory of the first network device, and an estimated swap of coverage of the first network device.

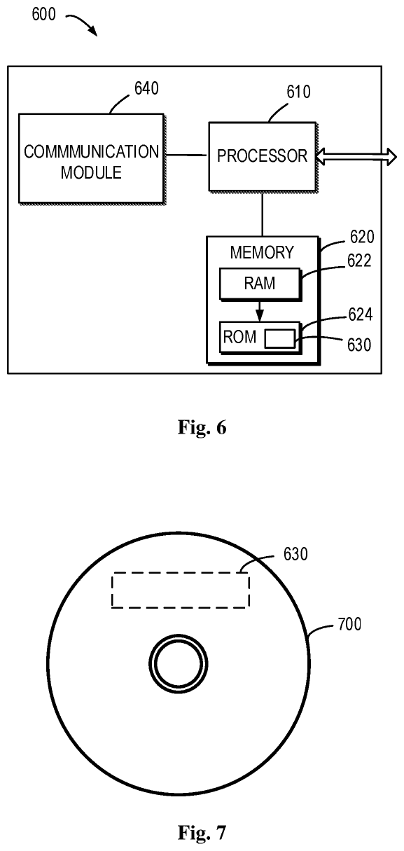

FIG. 6 is a simplified block diagram of a device 600 that is suitable for implementing embodiments of the present disclosure. The device 600 may be provided to implement the communication device, for example the terminal device 110-1, the first network device 120-1 and the second network device 120-2 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 620. The processor 610 may perform any suitable actions and processing by loading the program 630 into the RAM 620.

The embodiments of the present disclosure may be implemented by means of the program 630 so that the device 600 may perform any process of the disclosure as discussed with reference to FIGS. 3 to 5. The embodiments of the present disclosure may also be implemented by hardware or by a combination of software and hardware.

In some embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7 shows an example of the computer readable medium 700 in form of CD or DVD. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 300, 400 or 500 as described above with reference to FIGS. 3-5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-29. (canceled)

30. A terminal device comprising:
at least one processor; and
at least one memory including computer program codes;
the at least one memory and the computer program codes are configured to, with the at least one processor, cause the terminal device at least to:
upon a successful handover to a first target cell in an ordered list of target cells configured for the terminal device to initiate handover in order, determine information for assessing a validity of the ordered list; and
transmit, to a first network device providing the first target cell, a first message comprising the information for assessing the validity of the ordered list.

31. The terminal device of claim 30, wherein the information for assessing the validity of the ordered list comprises at least one of the following:
an index of the first target cell in the ordered list,
information indicating at least one target cell remaining in the ordered list to which the terminal device is to handover to, or
a number of target cells remaining in the ordered list to which the terminal device is to handover.

32. The terminal device of claim 30, wherein the at least one memory and the computer program codes are configured to, with the at least one processor, cause the terminal device to determine the information for assessing a validity of the ordered list by:
measuring, based on a measurement configuration configured by the first network device, at least one signal from at least one candidate cell to handover to; and
generating the first message comprising a result for measuring the at least one signal.

33. The terminal device of claim 30, wherein the at least one memory and the computer program codes are configured to, with the at least one processor, cause the terminal device to determine the information for assessing a validity of the ordered list by:
in accordance with a determination that no handover is initiated toward one of the target cells in the order listed until expiration of a validity timer associated with the ordered list, generating the first message comprising a first indication indicating no handover toward the order listed of target cells is performed.

34. The terminal device of claim 30, wherein the at least one memory and the computer program codes are configured to, with the at least one processor, further cause the terminal device to:
receive, from the first network device, a second message comprising a second indication indicating the ordered list of target cells being valid;
in accordance with a determination that a handover condition is met, initiate handover from the first target cell to a second target cell based on a configuration of the ordered list, the second target cell configured with a second index listed next to a first index of the first target cell in the ordered list, and the second target cell selected from at least one target cell configured with the second index.

35. The terminal device of claim 30, wherein the at least one memory and the computer program codes are configured to, with the at least one processor, further cause the terminal device to:
receive, from the first network device, a third message comprising a configuration for handover to a third target cell determined based on the information for assessing a validity of the ordered list, the third target cell being different from at least one target cell configured with a second index listed next to a first index of the first target cell in the ordered list; and
in accordance with a determination that a handover condition is met, initiate handover from the first target cell to the third target cell based on the configuration for handover to the third target cell.

36. The terminal device of claim 30, wherein the third message further comprises a configuration of a further ordered list of target cells comprising the third target cell, the third target cell is selected from at least one target cell configured with a specific index in the further ordered list, and the further ordered list is at least partially different from the ordered list.

37. A first network device comprising:
at least one processor; and
at least one memory including computer program codes;
the at least one memory and the computer program codes are configured to, with the at least one processor, cause the first network device at least to:
upon a successful handover of a terminal device to a first target cell provided by the first network device, determine a stay time of the terminal device in the first target cell, the first target cell being one of an ordered list of target cells for the terminal device to initiate handover in order; and
cause at least one further cell to prepare for at least one upcoming handover based on the stay time.

38. The first network device of claim 37, wherein the stay time is determined based on at least one of the following:
a cell identity of the first target cell,
geo-location data of the terminal device,
a movement of the terminal device comprising at least one of a moving speed or a moving direction of the terminal device,
a moving speed of the first network device,
an estimated trajectory of the first network device, and
an estimated swap of coverage of the first network device.

39. The first network device of claim 37, wherein the at least one memory and the computer program codes are configured to, with the at least one processor, cause the first network device to determine the stay time by:
receiving, from the terminal device, a first message comprising information for assessing a validity of the ordered list; and
determining the stay time based on the information.

40. The first network device of claim 39, wherein the information for assessing the validity of the ordered list comprises at least one of the following:
an index of the first target cell in the ordered list,
information indicating at least one target cell remaining in the ordered list to which the terminal device is to handover to, or
a number of target cells remaining in the ordered list to which the terminal device is to handover.

41. The first network device of claim 39, wherein the information for assessing a validity of the ordered list comprises a result for measuring at least one signal from at least one candidate cell to handover to, and wherein the at least one memory and the computer program codes are configured to, with the at least one processor, further cause the first network device to:
transmit, to the terminal device, a measurement configuration for measuring the at least one signal from the at least one candidate cell.

42. The first network device of claim 39, wherein the information for assessing a validity of the ordered list comprises a first indication indicating no handover toward the order listed of target cells is performed until expiration of a validity timer associated with the ordered list.

43. The first network device of claim 39, wherein the at least one memory and the computer program codes are configured to, with the at least one processor, further cause the first network device to:
determine whether the ordered list of target cells is valid based on the information; and
in accordance with a determination that the ordered list of target cells is valid, transmit, to the terminal device, a second message comprising a second indication indicating the ordered list of target cells being valid.

44. The first network device of claim 39, wherein the at least one memory and the computer program codes are configured to, with the at least one processor, further cause the first network device to:
determine whether the ordered list of target cells is valid based on the information; and
in accordance with a determination that the ordered list of target cells is invalid, determine a third target cell for the terminal device to handover to, the third target cell being different from at least one target cell configured with a second index listed next to a first index of the first target cell in the ordered list; and
transmit, to the terminal device, a third message comprising a configuration for handover to a third target cell.

45. The first network device of claim 44, wherein the third message further comprises a configuration of a further ordered list of target cells comprising the third target cell, and at least one target cell is configured for each of indices in the ordered list.

46. The first network device of claim 37, wherein the at least one memory and the computer program codes are configured to, with the at least one processor, cause the first network device to cause at least one further cell to prepare for the at least one upcoming handover by:
transmitting, to a second network device providing the at least one further cell, a fourth message indicating the stay time.

47. The first network device of claim 37, wherein the at least one further cell is provided by the first network device, and wherein the at least one memory and the computer program codes are configured to, with the at least one processor, cause the first network device to cause at least one further cell to prepare for the at least one upcoming handover by:
reserving, based on the stay time, resources from the at least one further cell for the at least one upcoming handover.

48. A second network device comprising:
at least one processor; and
at least one memory including computer program codes;
the at least one memory and the computer program codes are configured to, with the at least one processor, cause the second network device at least to:
receive, from a first network device providing a first target cell, a fourth message indicating a stay time of the terminal device in the first target cell, the first target cell being one of an ordered list of target cells for the terminal device to initiate handover in order; and
reserve, based on the stay time, resources from at least one further cell for at least one upcoming handover of the terminal device, the at least one further cell provided by the second network device.

49. The second network device of claim 48, wherein the at least one further cell comprises a second target cell configured with a second index listed next to a first index of the first target cell in the ordered list; or
wherein the at least one further cell comprises a third target cell different from at least one target cell configured with a second index listed next to a first index of the first target cell in the ordered list.
